(19) United States
(12) Patent Application Publication
(10) Pub. No.: US 2008/0178392 A1
(43) Pub. Date: Jul. 31, 2008

(54) Air Cushion with Alternatively Inflated Chambers

(76) Inventor: Guo Feng Chu, Hong Kong (HK)

Correspondence Address: VEDDER PRICE P.C., 222 N. LASALLE STREET, CHICAGO, IL, 60601, US

(21) Appl. No.: 11/668,295

(22) Filed: Jan. 29, 2007

(51) Int. Cl. A61G 7/057

(52) U.S. Cl. 5/713

(57) ABSTRACT

An air cushion having a first and second set of flexible air chambers providing alternative up and down motion when inflated and deflated, wherein each set of air chambers includes a primary channel branching into a plurality of secondary channels. An air supply device is connected to the two sets of air chambers for alternatively inflating and deflating each said set of air chambers. The secondary channels are arranged in an alternative manner to provide alternate up and down motion. The primary channel is connected with each of the secondary channels and conducts air directly between the secondary channels and an air supply device.

### TECHNICAL FIELD

The present invention relates generally to an air cushion, in particular, an air cushion which provides alternate up and down motion.

### BACKGROUND

Bed sores or pressure sores (also known as pressure ulcers or decubitus ulcers) are developed when a person lies on his back or sits in the same position for an extended period of time. The sores occur when constant pressure is applied to a vulnerable area of the skin causing a shortage of blood supply. Bed sores are common to bed-ridden patients or people of certain patterns of sleeping behavior, and may occur at areas including lower back, hips, and bony protruding areas such as shoulders, elbows, ankles, knees, heels, and ears. Pressure sores may also result from prolonged sitting and usually occur at the hip and the lower back. People using wheelchairs and commercial vehicle drivers are particularly susceptible.

Bed sores can be prevented by providing gentle motion to and air circulation at the vulnerable skin area. An air mattress with alternatively arranged air chambers which provide alternate up and down motion and air circulation to the user's body is an existing device for preventing bed sores.

FIG. 1 shows an example of such air mattress. Two sets of air chambers are alternatively arranged to provide alternate up and down motions. The air chambers of each set are connected by air tubes and are tied together by straps. A disadvantage is that such air mattress is made of numerous components and the assembly process of such air mattress is time-consuming and costly.

Another disadvantage is that such air mattress does not provide a full up and down motion to the arms of the user lying flat on the air mattress to prevent bed sores being developed on the upper limbs, for example, at the shoulder and the elbow areas.

There is therefore a need for an improved air cushion to address all or some of the issues described above.

### SUMMARY OF THE INVENTION

The object of the present invention is to provide an improved air cushion which can be manufactured by few assembling steps.

In accordance with the present invention, there is provided an air cushion having a first and second set of flexible air chambers providing alternative up and down motion upon inflation and deflation by force of air, wherein each set of air chambers includes a primary channel branching into a plurality of secondary channels. An air supply device is connected to the two sets of air chambers for alternatively inflating and deflating each said set of air chambers. The secondary channels are arranged in an alternative manner to provide alternate up and down motion.

The primary channel is connected with each of the secondary channels and conducts air directly between the secondary channels and the air supply device.

Preferably, the primary channel is disposed on the sides along the open ends and the closed ends of the secondary channels, such that the primary channel also provides up and down motion to the whole upper limbs of the user upon inflation and deflation of the air chambers.

Alternatively, the primary channel has a straight portion in association with the secondary channels for providing a smooth circulation of air between the secondary channels and the air supply device.

In another embodiment, the adjacent secondary channels are substantially detached from each other to provide spacing therebetween to avoid crumpling of the air cushion resulting from the inflation of the air chambers, while the first and second set of air chambers are remain attached as one unit.

In yet another embodiment, the air cushion is formed by a first sheet and a second sheet sealingly fastened together at the peripheral edges of the air chambers to form a seam. The seam between the adjacent channels is substantially cut through lengthwise to form a slit, such that spacing is provided between the adjacent channels to avoid crumpling of the air cushion resulting from the inflation of the air chambers. The seam is not completely cut through lengthwise such that the first and second set of air chambers remain attached as one unit.

Alternatively, the channels includes smooth rounded turns to avoid force from concentrating on a point on the air chamber during inflation and therefore tearing the air chamber at such point.

### BRIEF DESCRIPTION OF DRAWINGS

The above and other aspects, features, and advantages of the present invention will become more apparent upon consideration of the following detailed description of preferred embodiments, taken in conjunction with the accompanying drawing figures, wherein:—

FIG. 1 is a perspective view of an air mattress of the prior art;

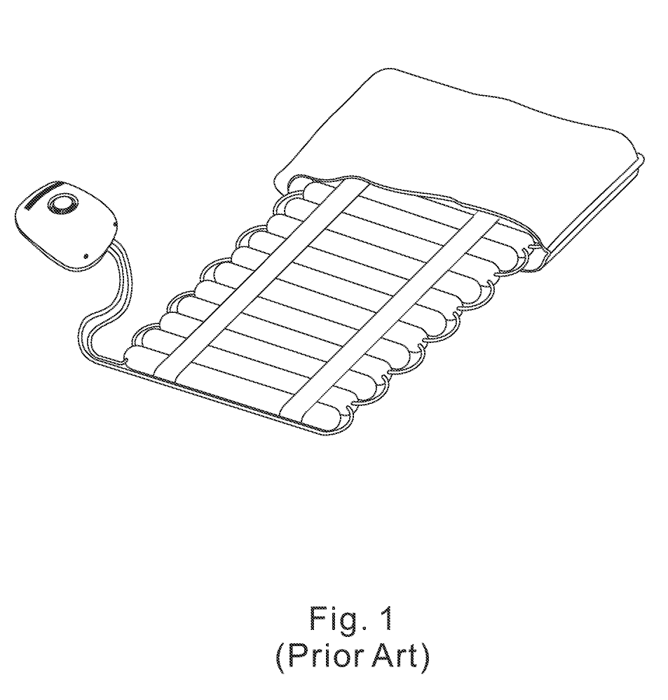

FIG. 2 is a perspective view of an embodiment of this invention;

FIG. 3 is a top view of the embodiment of FIG. 2;

FIG. 4 is a sectional view of the embodiment of FIG. 2;

FIG. 5 is a block diagram showing the arrangement of an air supply device according to an embodiment of this invention;

FIGS. 6a and 6b illustrate the arrangement of a 3-port valve according to the embodiment of FIG. 5;

FIG. 7 is a block diagram showing the arrangement of an air supply device according to another embodiment of this invention;

FIG. 8 illustrates the arrangement of air tubes according to the embodiment of FIG. 7; and

FIG. 9 is a top view of another embodiment of this invention.

### DETAILED DESCRIPTION OF A PREFERRED EMBODIMENT

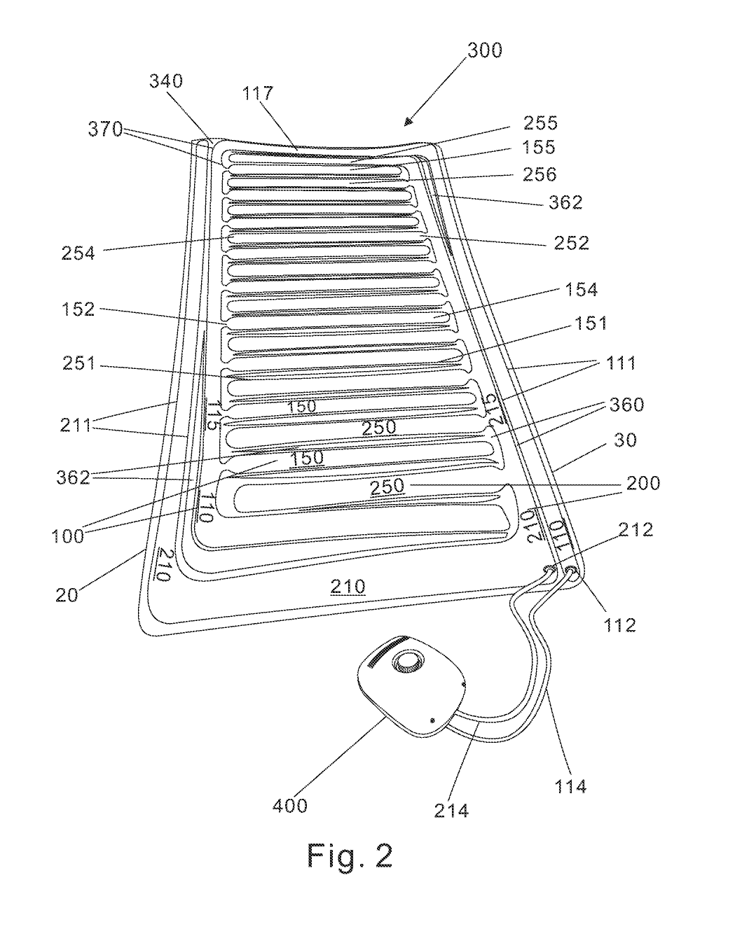

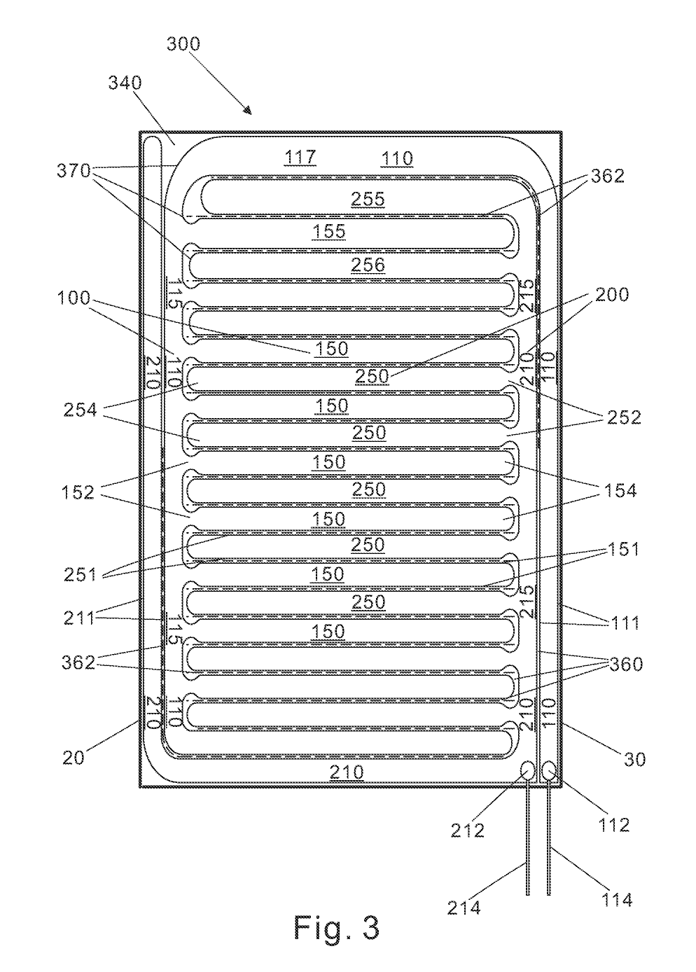

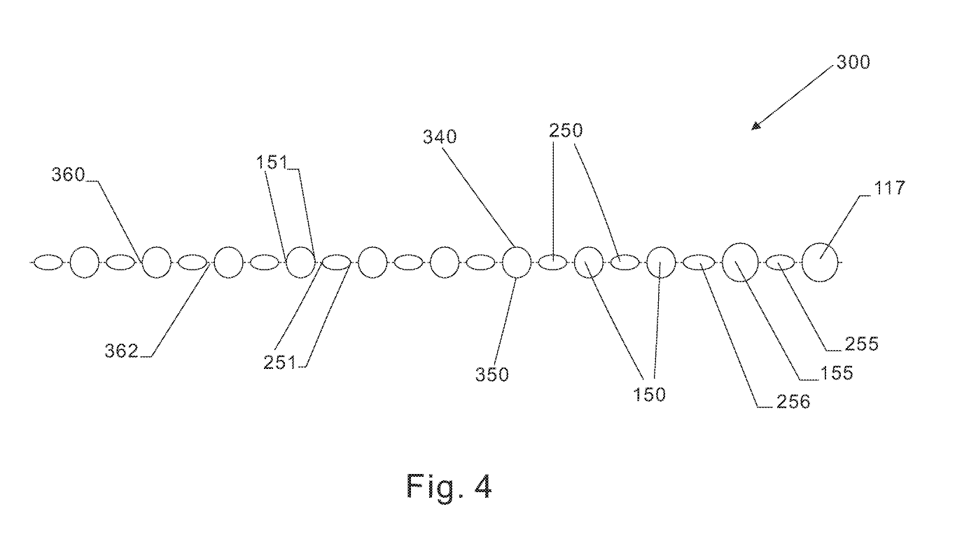

As illustrated in FIGS. 2, 3 and 4, an air cushion 300 according to an embodiment of this invention includes two independent sets of flexible air chambers 100, 200. Each set of air chambers 100, 200 contains a primary channel 110, 210 and a number of secondary channels 150, 250. The air chambers are made of a stretchable and abrasion-resistant material to prevent damage and leakage, such as polyvinyl chloride polymer (PVC).

The primary channel 110, 210 contains an air inlet 112, 212 connected to an air tube 114, 214. The primary channel 110, 210 branches into a number of the secondary channels 150, 250 and conducts air into and out of the secondary channels 150, 250 during the inflation and deflation of the set of air chambers 100, 200.

Each secondary channel 150, 250 contains an open end 152, 252 connected with the primary channel 110, 210 and a closed end 154, 254. The secondary channels 150, 250 of the first and second set of air chambers 100, 200 are arranged alternatively to provide an alternate up and down motion. By way of example, the secondary channels 150, 250 are arranged alternatively to each other in parallel. The open ends 152 and the closed ends 154 of the secondary channels 150 of the first set of air chambers 100 are positioned opposite to the counterpart open ends 252 and closed ends 254 of the secondary channels 250 of the second set of air chambers 200.

The radial size of the secondary channels 150, 250 and the various portions of the primary channel 110, 210, for example, measured by diameter, may vary for different parts of the body. By way of example, the diameters of the secondary channels 155, 255, 256 and the portion 117 of the primary channel 110 adjacent to the secondary channel 255 are slightly larger than and gradually reduce to the same diameters of the rest of the secondary channels 150, 250 to form a pillow and give a more comfortable support to the head portion of the body.

In use, the primary channel 110 and the secondary channels 150 of the first set of air chambers 100 will be inflated first for a specific period of time to provide an upward motion and to support the user. At the same time, the primary channel 210 and the secondary channels 250 of the second set of air chambers 200 will be deflated. Thereafter, the inflation and deflation of the first and second set of air chambers 100, 200 will be reversed, resulting in a periodic and alternative up and down motion on the user's body.

The primary channels 110, 210 are positioned on the side along the open ends 152, 252 of the secondary channels 150, 250 in order to associate with the open ends 152, 252 and on the side along the closed ends 154, 254 of the secondary channels 150, 250. Such arrangement allows the primary channels 110, 210 to be arranged on the left side 20 and the right side 30 of the air cushion 300 to provide up and down motion to the upper limbs of the user, including the shoulder and elbow areas. The primary channels 110, 210 are also engaged in alternate up and down motion. The whole upper limbs of the user will be continuously raised and lowered in a very slow motion during the inflation and deflation without the user knowing it at sleep.

The primary channels 110, 210 contain straight portions 115, 215 for associating with the open ends 152, 252 of the secondary channels 150, 250. The straight portions 115, 215 facilitate a smooth and uninterrupted circulation of air into and out of the secondary channels 150, 250.

The adjacent channels 110, 150, 210, 250 are detached from each other such that there is sufficient spacing between the adjacent channels, otherwise the stretching of the air chambers during inflation will cause the air cushion 300 to crumple and distort in an irregular shape.

In an embodiment of this invention, the air cushion 300 comprises a first sheet 340 and a second sheet 350 being sealingly fastened together at the peripheral edges 111, 151, 211, 251 of the air chambers along the primary and secondary channels 110, 150, 210, 250, where the two sheets 340, 350 are joined by thermal welding, sewing or the like to form a seam 360. The seams 360 are then cut through lengthwise substantially to form slits 362. The slits 362 provide space between the adjacent channels to avoid the crumpling and distortion during inflation of the air chambers at the channels 110, 150, 210, 250. The slits 362 are not completely cut through lengthwise such that the two adjacent air chambers are still partially attached with each other, and therefore the two sets of air chambers 100, 200 remain attached as a single piece.

The channels 110, 150, 210, 250 contain only smooth rounded turns 370, for example at the peripheral edges 111, 151, 211, 251, and are free of any sharp turning points at which force is concentrated on during inflation of the air chambers. The rounded turns 370 make the air chambers more durable against repeated inflation.

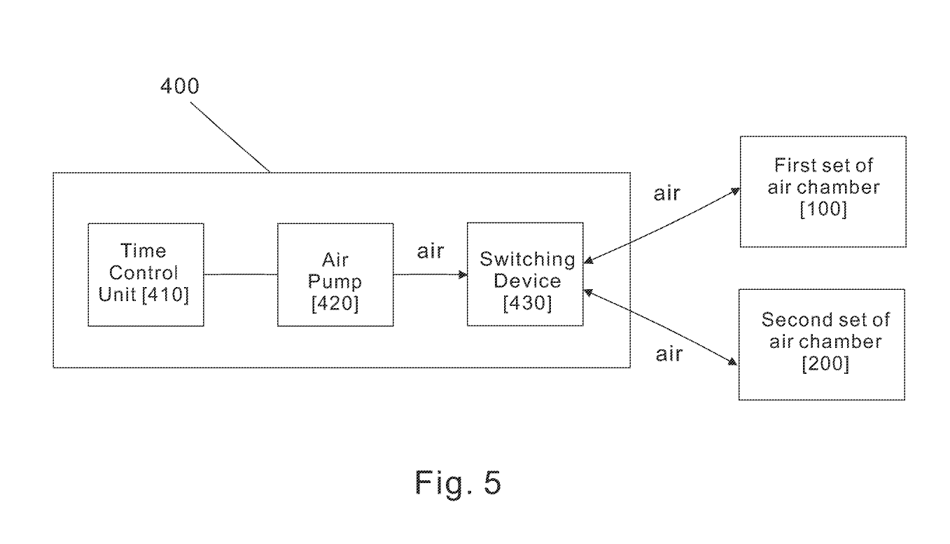

The air tubes 114, 214 are connected to an air supply device 400. As illustrated in FIG. 5, the air supply device 400 includes a time control unit 410, an air pump 420 and a switching device 430.

The time control unit 410 controls the time period for alternatively inflating and deflating the first and second set of air chambers 100, 200. The switching device 430 diverts the air generated from the air pump 420 alternatively into the first and the second set of air chambers 100, 200 under the control of the time control unit 410. The user may adjust the time control unit 410 to set the time period for inflation and deflation and control the speed of the up and down motion.

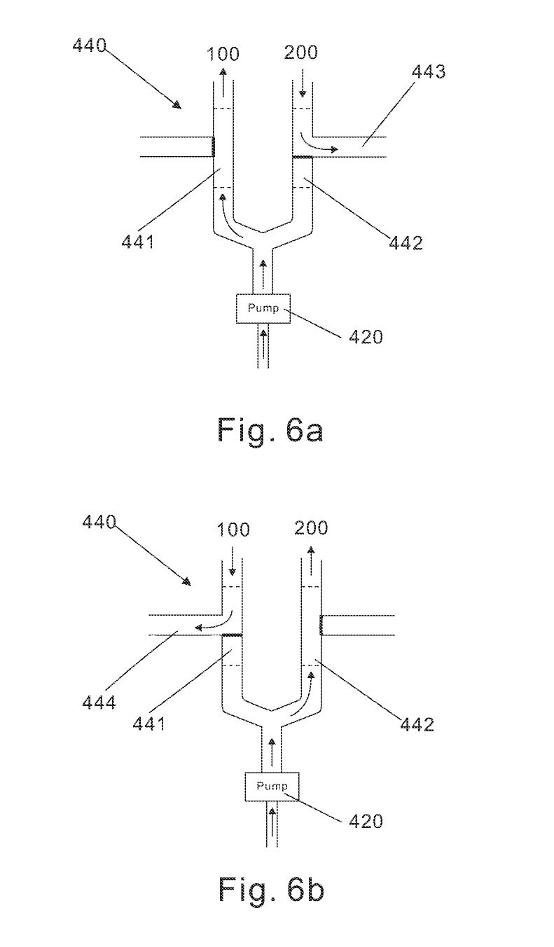

As illustrated in FIGS. 6a and 6b, the switching device 430 may, for example, be a 3-port valve 440. In FIG. 6a, the first set of air chambers 100 is being inflated while the second set of air chambers 200 is being deflated. A port 441 connecting to the first set of air chambers 100 is open to allow air to pump in while a port 442 connecting to the second set of air chambers 200 is closed. The air is allowed to flow out from the second set of air chambers 200 through an air outlet 443.

Alternatively, in FIG. 6b, the second set of air chambers 200 is being inflated while the first set of air chambers 200 is being deflated. The port 442 connecting to the second set of air chambers 200 is open to allow air to pump in while the port 441 connecting to the first set of air chambers 100 is closed. The air is allowed to flow out from the first set of air chambers 100 through an air outlet 444.

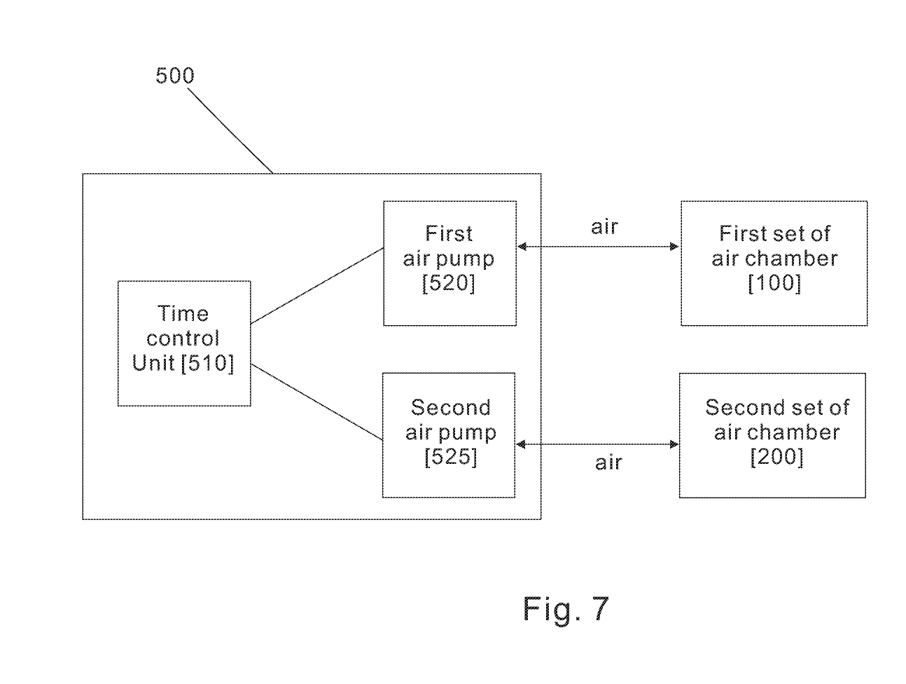

Another embodiment of an air supply device 500 is illustrated in FIG. 7. The air supply device 500 includes a time control unit 510 and a first air pump 520 and a second air pump 525. The time control unit 510 controls the operation of the first and second air pumps 520, 525 to inflate and deflate the first and second set of air chambers 100, 200 alternatively.

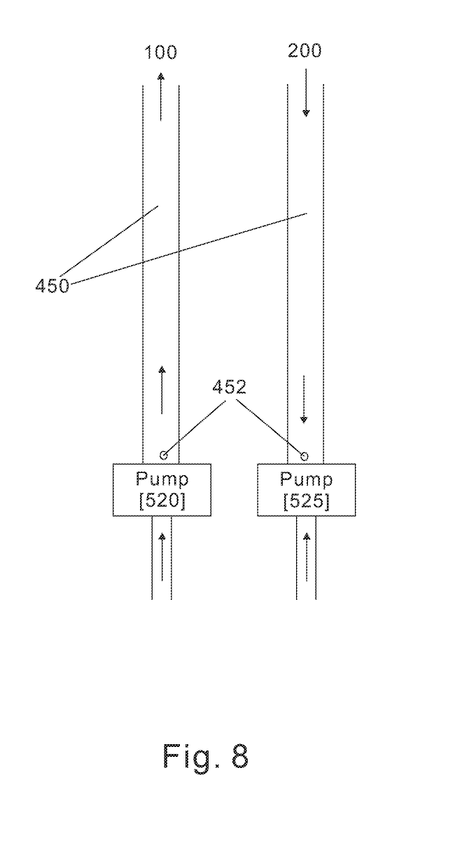

As illustrated in FIG. 8, each of the first and second air pumps 520, 525 are respectively connected to the first and second set of air chambers 100, 200 by an air tube 450. The air tube 450 contains a tiny hole 452 at an end near the air pump. When air is continuously supplied into the air tube 450 by the air pump to inflate the set of air chamber, the loss of air through the hole 452 is insignificant. During the deflation of the set of air chambers, no air is supplied from the air pump and the weight of the user generates a pressure to force the air out of the air chambers and out of the hole 452.

The air cushion 300 is not restricted to be used by human, and may be used as a sleeping pad for a pet, in particular, for the aged animal.

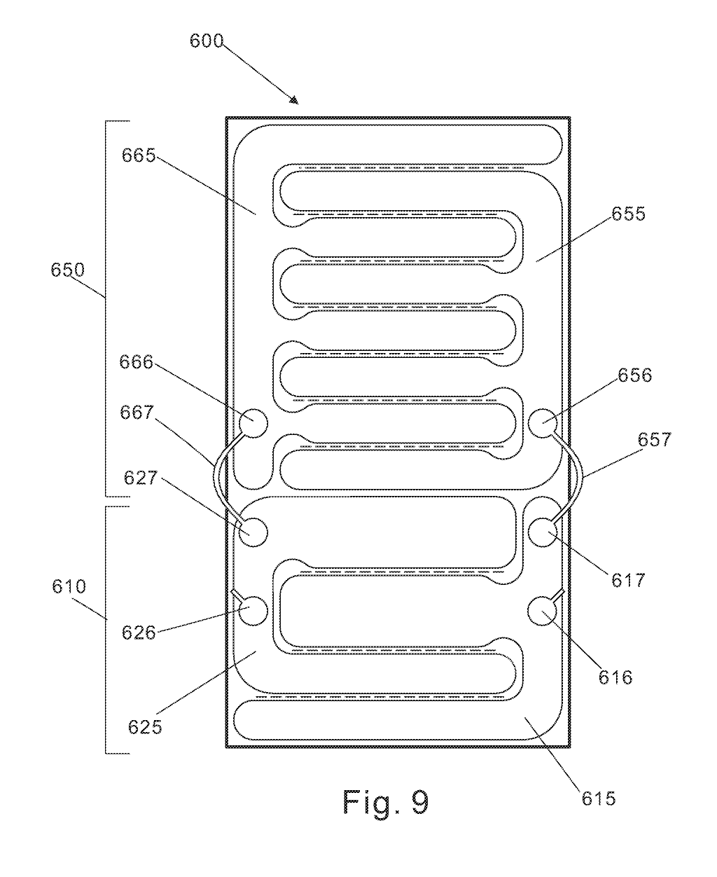

FIG. 9 illustrates another embodiment of this invention. An air cushion 600 provides motion to both the back and the hip of the user. The air cushion 600 for a seat contains a base portion 610 and a back portion 650. The base portion 610 is placed on a seat base while the back portion 650 is attached to the seat back.

The base portion 610 and the back portion 650 each has a similar structure of the air cushion 300 illustrated in FIGS. 2, 3 and 4. Each set of air chambers 615, 625 of the base portion 610 contains an air inlet 616, 626 connecting to an air pump, and an air outlet 617, 627 connecting to a corresponding air inlet 656, 666 of each set of air chambers 655, 665 of the back portion 650 by an air tube 657, 667. The sets of air chambers 615, 655 are inflated and deflated alternatively with respect to the sets of air chambers 625, 665 to provide alternate motion to the user's back and hip.

While the invention has been described in detail with reference to disclosed embodiments, various modifications within the scope of the invention will be apparent to those of ordinary skill in this field. It is to be appreciated that features described with respect to one embodiment typically may be applied to other embodiments.

What is claimed is:

1. An air cushion, comprising:
a first and a second set of flexible air chambers for providing alternative up and down motion to the body of a user when inflated and deflated, wherein each said set of air chambers further comprises:
a primary channel branching into a plurality of secondary channels, wherein the primary channels of said first and second set of air chambers provide alternate up and down motion;
a plurality of secondary channels each having an open end connected with said primary channel for supporting the main body of the user, wherein the secondary channels of said first and second set of air chambers are alternatively arranged for providing alternate up and down motion;
an air supply device connected to said first and second set of air chambers for alternatively inflating and deflating each said set of air chambers;
whereby said primary channels conducts air directly between each said secondary channels and said air supply device.

2. The air cushion as recited in claim 1, wherein each said secondary channel having a closed end, each set of air chamber having a first side along said open ends and a second side along said closed ends of the secondary channels, the primary channel is disposed to surround the secondary channels on said first and second sides,
whereby said primary channel provides up and down motion to the upper limbs of the user upon inflation and deflation of the air chambers.

3. The air cushion as recited in claim 1, wherein each said primary channel further comprises a straight portion in association with the open ends of said secondary channels for providing smooth air circulation between said secondary channels and said air supply device.

4. The air cushion as recited in claim 1, wherein the adjacent said channels of the first and second set of air chambers are substantially detached from each other to provide spacing between the adjacent channels to avoid crumpling of the air cushion resulting from the inflation of said air chambers,
wherein said first and second set of air chambers remain attached as one unit.

5. The air cushion as recited in claim 1, wherein each said air chamber further comprises peripheral edges, said air cushion further comprises:
a first sheet and a corresponding second sheet, said sheets are sealingly fastened together at the peripheral edges of said air chambers to form a seam between said sets of air chambers, wherein a slit is formed lengthwise along said seam to substantially separate the adjacent channels, providing spacing between the adjacent channels to avoid crumpling of the air cushion resulting from the inflation of said air chambers,
wherein said first and second set of air chambers remain attached as one unit.

6. The air cushion as recited in claim 1, wherein each said channel comprises smooth rounded turns to avoid force from concentrating on a point to damage the air chamber during inflation.

7. The air cushion as recited in claim 1, wherein said air supply device further comprises:
an air pump;
a switching device disposed between said air pump and said first and second set of air chambers for alternatively diverting air in and out of each said set of air chambers; and
a time control unit for controlling said switching device to switch between said first and second set of air chambers periodically.

8. The air cushion as recited in claim 1, wherein said air supply device further comprises:
a first air pump connected with said first set of air chambers;
a second air pump connected with said second set of air chambers; and
a time control unit for controlling said first and second air pump to alternatively inflate and deflate said first and second set of air chambers periodically.

9. The air cushion as recited in claim 1, wherein said secondary channels of said first and second set of air chambers are arranged in parallel to each other.

10. The air cushion as recited in claim 1, wherein said air cushion having an end for accommodating the head portion of a user, the primary channel having a portion at said end with a radial size, the adjacent secondary channel having a radial size, wherein the radial size of said portion of the primary channel is larger than the radial size of the secondary channel.

11. The air cushion as recited in claim 1, wherein said air cushion having an end for accommodating the head portion of a user, the secondary channel near said end having a radial size, the radial size of the secondary channel towards said end is larger than the radial size of another adjacent secondary channel.

12. The air cushion as recited in claim 1, wherein said air cushion having an end for accommodating the head portion of a user, the primary channel having a portion at said end with a radial size, the secondary channel near said end having a radial size, the radial sizes of the primary channel and the secondary channels reduce gradually from said end,
whereby a tapering portion of the air cushion is formed at said end to accommodate the head portion of the user.
